(19) United States
(12) Patent Application Publication
(10) Pub. No.: US 2008/0013333 A1
(43) Pub. Date: Jan. 17, 2008

(54) Vehicular lamp

(75) Inventors: Hiroya Koizumi, Shizuoka (JP); Kazunori Natsume, Shizuoka (JP)

Correspondence Address: QUINN EMANUEL;KODA & ANDROLIA, 865 S. FIGUEROA STREET, 10TH FLOOR, LOS ANGELES, CA, 90017, US

(73) Assignee: Koito Manufacturing Co., Ltd.

(21) Appl. No.: 11/811,822

(22) Filed: Jun. 12, 2007

(30) Foreign Application Priority Data
Jun. 28, 2006 (JP) 2006-177611

(51) Int. Cl. F21V 8/00; F21V 7/00

(52) U.S. Cl. 362/511

(57) ABSTRACT

A vehicular lamp including an LED(s), a reflector having a reflective surface that reflects light from the LED(s) in the forward direction of the lamp, and a flat (plate-like) light guide(s) to which the light from the LED(s) is incident from one side of the light guide(s) and which radiates the light in the forward direction from another side. Light in the vicinity of the optical axis of the LED(s) is incident to the light guide(s), and other light is reflected by the reflective surface of the reflector, so that a part of light of the LED(s) is irradiated by the light guide(s), and other light is reflected and irradiated by the reflector, thus reducing the number of LEDs used and the size and power consumption of the lamp.

### BACKGROUND OF THE INVENTION

1. Field of the Invention

The present invention relates to a lamp suitably used as a marker lamp in a vehicle such as an automobile and more particularly to a vehicular lamp having a striped light-emitting area on the light-emitting surface.

2. Description of the Related Art

Various vehicular lamps that have novel light-emitting surfaces, especially marker lamps such as tail lamps and turn signal lamps, have been proposed in view of the demands to the design of vehicles. In one type of such a vehicular lamp, the light-emitting area with a striped configuration is defined on a part of the lamp light-emitting surface up to a plurality of locations, and such a striped area is designed so as to emit light with brightness, color, etc., different from other areas.

For example, in the combination lamp disclosed in Japanese Patent Application Laid-Open (Kokai) No. 2006-49232, a plurality of lamps are disposed in the lamp body, and a light guide with a striped configuration that extends in the downward direction when viewed from the front is disposed inside the lamp body. The light source such as an LED (light-emitting diode) is disposed on the rear end surface side of the light guide. Light radiated from the LED is thus guided to the inside portion of the light guide and then radiated from the front end surface of the light guide, i.e., from the front surface of the lamp. Accordingly, if the lamp is viewed from the front direction while the LED is emitting the light, the front end surface of the light guide emits light with a high luminous intensity in a striped configuration. Regardless of whether the other lamps in the lamp body are lit, the light-emitting area with the striped configuration remains particularly noticeable, providing a lamp that is novel in terms of design.

The above-described lamp of Japanese Patent Application Laid-Open (Kokai) No. 2006-49232 uses an LED as the light source only for the purpose of emitting the light from the light guide. This is because the LED generally has a more narrow emission angular range compared to light bulbs and is therefore not suitable for emitting light over a wide range of surface area. Using an LED to emit light over the entire area of a lamp whose front surface has a large surface area requires a great number of LEDs. This in turn complicates the lamp structure and raises the costs of the lamps. As a result, in the lamp of Japanese Patent Application Laid-Open (Kokai) No. 2006-49232, a light bulb separate from the LED is provided as a light source for obtaining a wide light-emitting area. However, it is difficult to reduce the size of the lamp because the light bulb must be provided separately from the LED so that heat generated by the bulb does not affect the LED. Furthermore, since light bulbs consume a large amount of power, it is not desirable to use them in terms of providing a lamp with low power consumption.

Meanwhile, the lamp disclosed in U.S. Pat. No. 6,796,695 has a large light-emitting surface with a use of only a small number of LEDs. This lamp is to reduce the dimension of the lamp in its optical axis direction; and in this lamp, an increase in the light-emitting surface area is achieved by using a reflector that has a plurality of reflective surfaces divided in a stepped configuration so as to reflect and diffuse light radiated from the LEDs.

In view of the above, a combination of the lamps disclosed in Japanese Patent Application Laid-Open (Kokai) No. 2006-49232 and U.S. Pat No. 6,796,695 can be considered. In other word, it is possible to form a lamp that includes a plurality of LEDs disposed in the lamp body, in which the light from a part of the LEDs is diffused by a reflector as taught by U.S. Pat. No. 6,796,695 to enlarge the light-emitting surface, and the light from the other LEDs is brought to be incident to a light guide as described in Japanese Patent Application Laid-Open (Kokai) No. 2006-49232 to form the light-emitting area to have a striped configuration. This lamp can be small in size and can be reduced in power consumption, and it is possible to have such a novel design that the light-emitting surface has partly a striped configuration.

However, in such a lamp, LEDs for radiating light onto the reflector and LEDs for radiating light onto the light guide must be separate ones. As a result, an excessively large number of LEDs are required to be installed in the lamp body, and it is difficult to realize lamps manufactured at a lower cost.

Furthermore, in the structure that the light-emitting area with a striped configuration is disposed in an area which is separated from another large light-emitting area as in Japanese Patent Application Laid-Open (Kokai) No. 2006-49232, there is substantially no problem. However, this is not the case for a lamp in which the light-emitting area with a striped configuration is provided in a part of the large light-emitting area. In such a structure, the reflector and the light guide disposed inside the lamp body must be provided so as to overlap in the optical axis direction. As a result, a part of light reflected by the reflector, which is positioned in the back of the light guide, and advancing toward the front of the lamp is blocked by the light guide or reduced by the light guide, and the amount of emitted light is lowered. This leads to a risk of losing desirable light distribution characteristics and of lowering the use efficiency of the light emitted by the LEDs.

### BRIEF SUMMARY OF THE INVENTION

Accordingly, it is an object of the present invention to provide a vehicular lamp that provides a novel design in which the light-emitting area having a striped configuration is provided in a part of the lamp light-emitting surface.

It is another object of the present invention to provide a vehicular lamp that reduces the quantity of the light source, such as an LED, thus contributing lowering of the cost, size, and power consumption of the lamp.

It is still another object of the present invention to provide a vehicular lamp in which the amount of light emitted is prevented from being reduced by the light guide, thus increasing the use efficiency of the light.

The above objects are accomplished by a unique structure of the present invention for a vehicular lamp that includes:

a light-emitting element,

a reflector having a reflective surface for reflecting light radiated from the light-emitting element in the forward direction of the lamp, and

a flat plate-shaped light guide provided on the front side of the reflector so that light radiated from the light-emitting element is incident from one side surface (rear side) of the light guide and radiated in the forward direction from another side surface (front side) of the light guide; and in this structure,

among light radiated from the light-emitting element, light in the vicinity of the optical axis of the light-emitting element is incident to the light guide, and light other than that which is in the vicinity of the optical axis of the light-emitting element is projected onto the reflective surface of the reflector.

According to the vehicular lamp of the present invention as described above, light of a high luminous intensity in the vicinity of the optical axis of the light-emitting element is guided by the light guide and emitted in a striped configuration to the front surface of the lamp, and light other than that which is in the vicinity of the optical axis of the light-emitting element is reflected by the reflector and substantially uniformly emitted to the front surface of the lamp. Accordingly, it is possible to provide a vehicular lamp that has such a novel design that a highly luminous light-emitting area with a striped configuration is provided among the uniform light-emitting area. In addition, light emission by the same light-emitting element via the light guide and light emission by reflection from the reflector can be both realized. Accordingly, in the vehicular lamp of the present invention, the lamp structure is simplified to achieve the reductions in size and cost, and it is also possible to reduce the power consumption of the lamp because of efficient use of the light.

In the lamp of the present invention, the surface of at least a part of the light guide can be provided so as to face the reflective surface of the reflector, so that light, which is incident to the light guide and radiated from the side surface of the light guide, is re-incident to the light guide. In this structure, it is possible to radiate light, which is reflected by the reflector, through the light guide. As a result, light radiated from the light-emitting element is effectively utilized, and light emission efficiency improves greatly.

Furthermore, in the lamp of the present invention, a plurality of light-emitting elements can be provided at a predetermined interval in the direction along the flat surface of the light guide, light from the respective light-emitting elements is incident to the light guide at a plurality of locations of such a flat surface of the light guide, and the reflector is provided with a plurality of reflective portions that reflect light, which is radiated from the light guide at a plurality of locations on the flat surface of the light guide, to be re-incident to the light guide. Accordingly, it is possible to uniformly illuminate the front surface of the lamp in the longitudinal direction along the flat surface of the light guide.

Furthermore, in the vehicular lamp of the present invention, the light guide can be formed thick by a plurality of thin flat plate-shaped light guides that are laminated in the thickness direction of the thin light guides. With this structure, it is possible to facilitate molding in various ways such as shortening the molding time when forming the light guide such that light is emitted from the striped area with a large width dimension. It is also possible to prevent the occurrence of shrinking and warping in the light guide.

In addition, in the present invention, the light guide can be colored so that it has substantially the same color as or similar color to the color of light emitted from the light-emitting element. With this arrangement, the color of the light guide reflects on the reflector when the lamp is not lit, and the lamp presents an external appearance of the same hue both in lit and unlit conditions, providing an improved design for the lamp.

### BRIEF DESCRIPTION OF THE SEVERAL VIEWS OF THE DRAWINGS

FIG. 1 is a front view of a vehicular lamp according to one embodiment of the present invention;

FIG. 2 is a horizontal cross-sectional view taken along the line II-II in FIG. 1;

FIG. 3 is a vertical cross-sectional view taken along the line III-III in FIG. 2;

FIG. 4 is a partial and exploded general perspective view of the lamp according to one embodiment of the present invention;

FIG. 5A through 5B schematically illustrate different lit states of the lamps of the present invention;

FIG. 6 is a horizontal cross-sectional view similar to FIG. 2 of the lamp according to another embodiment of the present invention;

FIG. 7 is a vertical cross-sectional view taken along the line VII-VII in FIG. 6;

FIG. 8 is a front view of the lamp according to still another embodiment of the present invention;

FIG. 9 is a vertical cross-sectional view taken along the line IX-IX in FIG. 8; and

FIGS. 10A and 10B are enlarged cross-sectional illustrations of the modified front ends of the light guides used in the present invention.

### DETAILED DESCRIPTION OF THE INVENTION

Embodiments of the present invention will be described below with reference to the accompanying drawings.

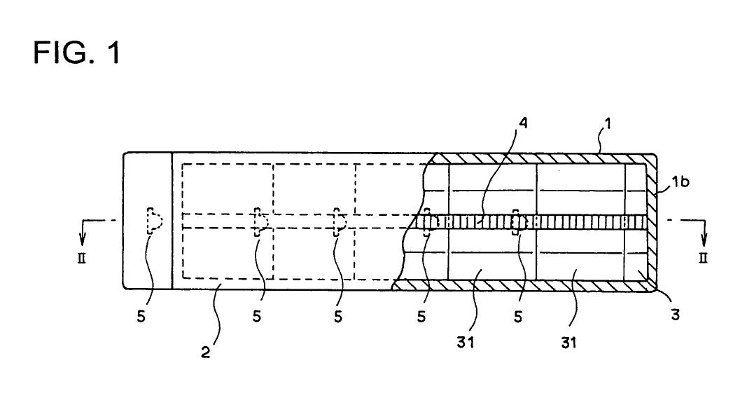

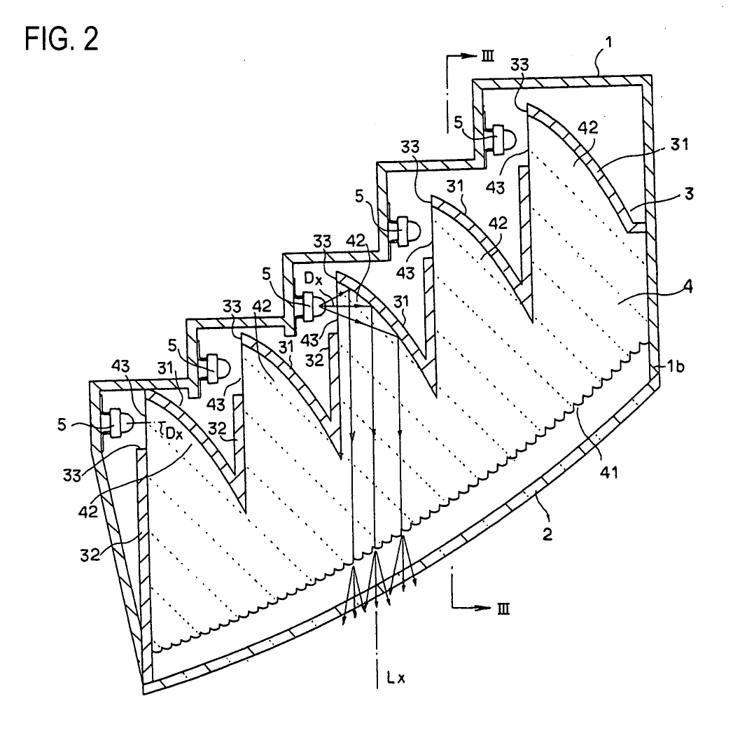

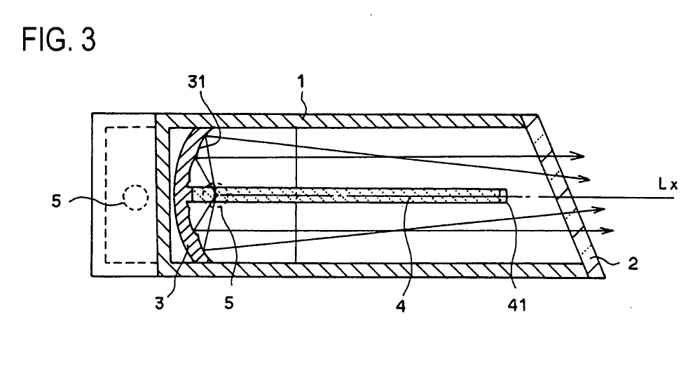

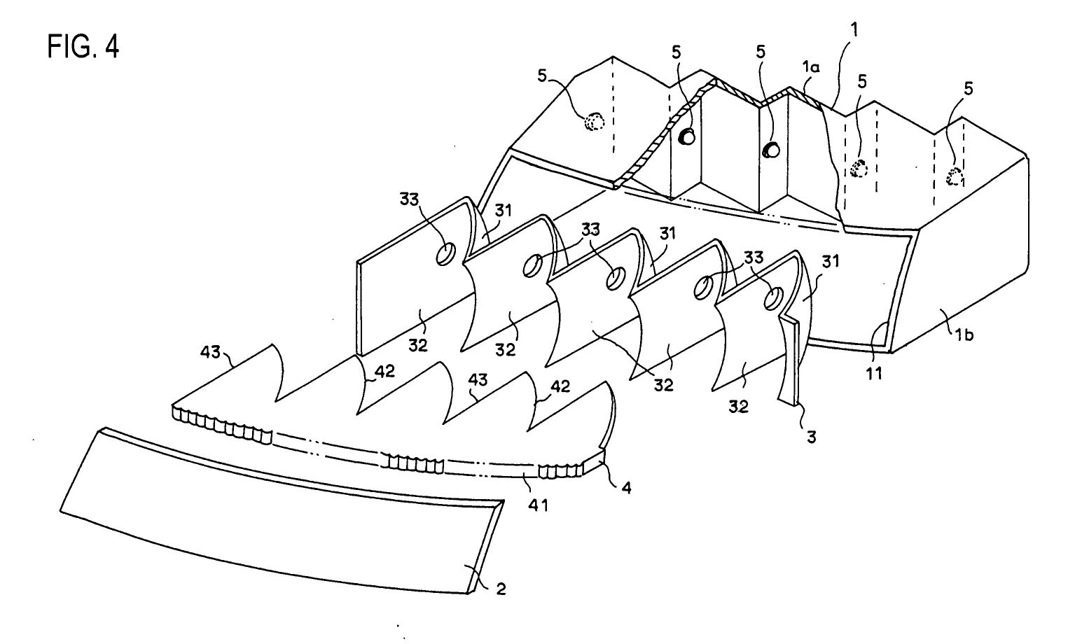

FIG. 1 is a front view of a part of the tail lamp of an automobile according to one embodiment of the present invention. FIG. 2 is a horizontal cross-sectional view of the lamp of FIG. 1, FIG. 3 is a vertical cross-sectional view of the structure shown in FIG. 2, and FIG. 4 is a disassembled perspective view of the lamp of FIG. 1. The tail lamp of the shown embodiment is a tail and stop lamp (T&SL) that combines the use of a stop lamp.

In FIGS. 1 through 4, an LED base 1, as best seen from FIG. 1, is formed in a horizontally oblong vessel configuration; and it comprises, as best seen from FIG. 4, a rear wall 1a, which is horizontally oblong as viewed from the front, and top, bottom, right, and left peripheral walls 1b.

The LED base 1 has a front opening 11 whose position in the lamp optical direction is inclined in the right-left direction (see FIG. 2) and up-down direction (see FIG. 3) of the lamp. The rear wall 1a (see FIG. 4) of the LED base 1 is formed in a stepped configuration so as to follow the inclination of the front opening 11. Attached to the front opening 11 is a front cover 2 that is formed from transparent resin; and the front cover 2 and the LED base 1 form a lamp chamber of the tail lamp.

Inside the LED base 1, a reflector 3 and a light guide 4 are provided; and they are fixedly supported on the LED base 1 by respective fixing means (not shown). A plurality of LEDs (light emitting elements) 5, which are the light source of the lamp, are mounted on the inner side of the rear wall 1a of the LED base 1. Light emitted from the LEDs 5 is radiated to the outside of the lamp through the front cover 2 after being reflected by the reflector 3 and/or passing through the light guide 4.

The reflector 3, as best seen from FIGS. 2 and 4, is structured by a plurality of divided reflective portions 31 (five reflective portions 31 in the shown embodiment) that are aligned in the lamp right-left direction as seen from FIG. 1. Each of the divided reflective portions 31 has such a configuration that a rotational parabolic surface thereof that rotates around the axis line is divided in two in the vertical direction along the axis line. Five divided reflective portions 31 are disposed such that mutually adjacent divided reflective portions 31 are, as seen from FIG. 2, staggered by a minute dimension in a direction along the lamp optical axis Lx and in line with an inclination angle of the front opening 11 of the LED base 1.

In the shown embodiment, the cross-section in the vertical direction of each one of the divided reflective portions 31 is in such a shape that parabolic surfaces of a two-stepped configuration (for a configuration with a total of four steps) are vertically connected, and respective focal positions of upper and lower steps that are divided by the light guide 4 as shown in FIG. 3 are in minute misalignment. In addition, the divided reflective portions 31 are connected in a state that adjacent divided reflective portions 31 are each optically isolated by barriers 32 that face in the lamp optical axis direction. Accordingly, the five divided reflective portions 31 are integrally structured to form the reflector 3.

The surfaces of the divided reflective portions 31 and the barriers 32 are processed by a surface treatment such as aluminizing or coating and structured to act as a light-reflecting mirror surface.

Light incident holes 33 are opened in the barriers 32 at center positions thereof in the vertical direction (up-down direction) so as to face in a direction orthogonal to the lamp optical axis direction.

The light guide 4 is flat with a predetermined thickness, thus being a flat plate-shaped member, and it is made of colorless transparent resins. The light guide 4 is disposed along the inner surface of the divided reflective portions 31 of the reflector 3. When the tail and stop lamp (T&SL) is viewed from the front as in FIG. 1, the light guide 4 is substantially at a center position in the vertical direction of the front cover 2, and it appears to have a striped configuration extending in the horizontal direction.

The front edge portion of the light guide 4 is, as best seen from FIG. 2, inclined (or curved) along the front cover 2, and a plurality of cylindrical steps 41 having a circular cross-sectional shape in the horizontal direction are formed in the horizontal direction on the front edge (or on the front end surface) of the light guide 4. The rear end surface of the light guide 4 is in a shape that matches the shape of the divided reflective portions 31 and barriers 32 of the reflector. In other words, the horizontal cross section of the light guide 4 has (or the top view of the light guide 4 appears to be) a serrated configuration that includes curved portions 42 of a semi-parabolic shape and straight portions that are parallel to the lamp optical axis Lx.

In the shown embodiment, as seen from FIG. 2, the rear end surface of the light guide 4 is in contact with the surfaces of the divided reflective portions 31 and barriers 32. In addition, a part of each one of the straight portions of the rear end surface of the light guide 4 faces each of the light incident holes 33 provided in the reflector 3 and acts as an incident surface 43.

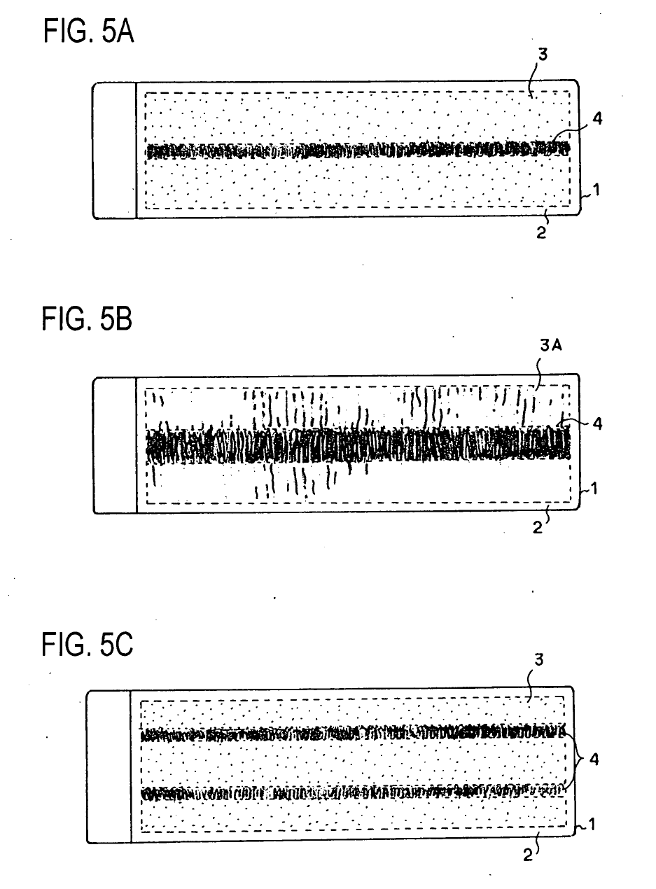

The LEDs 5 in the shown embodiment are discrete red LEDs. The LEDs 5 are fixed to the rear wall 1a formed in a stepped configuration of the LED base 1. More specifically, four LEDs 5 are fixed to the surfaces of the rear wall 1a that are along the lamp optical axis, and one LED 5 is fixed to the peripheral wall 1b that is located on the center side of the automobile (or on the left end wall 10b in FIG. 5). The LEDs 5 are respectively disposed at positions facing the light incident holes 33 of the reflector 3. Thus, the plurality of LEDs 5 (light-emitting elements) are provided at a predetermined interval in a direction along the flat surfaces of the light guide 4 as seen from FIG. 1. A wiring circuit (not shown) is integrally formed in the rear wall 1a, and the LEDs 5 are electrically connected to the wiring circuit and structured to act as a part of the predetermined circuit.

In addition, the optical axis Dx that is an optical axis of each one of the LEDs 5 is set to face the direction that is substantially perpendicular to the horizontal direction with respect to the lamp optical axis. Furthermore, a light-emitting point of each one of the LEDs 5 is disposed at a general focal position with respect to the parabolic surface of the curved portion 42 of the light guide 4. Light from each LED 5 which is incident to the light guide 4 is refracted toward the optical axis Dx of the LED (light emitting element) 5 by the incident surface 43. The focal position mentioned here is an optical focal position that takes this into consideration.

The above-described wiring circuit is connected to the lighting circuit (not shown) of the automobile. The wiring circuit is structured so that an electric current of a predetermined level is supplied to emit light when the tail lamp is lit, and an electric current of an even higher level is supplied so that the stop lamp emits light at a high luminance when the brake of the automobile is operated.

In the tail and stop lamp (T&SL) of the shown embodiment, it is possible to see the top FLAT surface of the light guide 4 as well as the divided reflective portions 31 and the barriers 32 of the reflector 3 through the front cover 2 of the lamp when the lamp is not lit. These surfaces are mirror surfaces of a silver color, and the light guide 4 is transparent with no color. Accordingly, when viewed from the front, the tail and stop lamp (T&SL) takes a colorless or silver external appearance as a whole. In this structure, the LEDs 5 are not visible from the outside of the lamp through the front cover 2, because the LEDs 5 are disposed, as seen from FIG. 2, at positions farther inward than the light incident hole 33 of the barriers 32 (or are disposed behind the divided reflective portions 31). Accordingly, the red color of the LEDs 5 does not affect the overall appearance of the lamp.

When the tail and stop lamp (T&SL) is lit, in other words, when electric current of a predetermined level is supplied to the LEDs 5 and light is emitted from the LEDs 5 that are acting as, for example, a tail lamp, then light radiated from the LEDs 5 are incident to the inner surface of the reflector 3 through the light incident holes 33.

Light near the optical axis Dx of each one of the LEDs 5 among such incident light enters from the incident surface 43 of the light guide 4 into the inside of the light guide 4, and then it advances in the light guide 4 to reach the front end surface and subsequently irradiates from the front end surface of the light guide 4. In addition, light radiated to the side further outward than the vicinity of the optical axis Dx of each one the LEDs 5 projects onto the top surfaces of the divided reflective portions 31 of the reflector 3 and is reflected in the lamp front direction, so that the light radiating from the front end surface of the light guide 4 and the light reflected by the reflector 3 form a coherent blended light flux and pass through the front cover 2, illuminating a directly forward direction of the lamp.

As seen from FIG. 2, light near the optical axis Dx of the LED 5 and light expanding somewhat leftward and rightward of the optical axis Dx among the light radiated from each LED 5 are incident to the light guide 4. Such light advances along the optical axis Dx of the LED (light emitting element) 5, which is substantially perpendicular to the lamp optical axis Lx, and is internally reflected on the curved portions 42, i.e., parabolic surfaces, of the rear end surface. Thereafter, the light is reflected as parallel light flux toward the direction along the lamp optical axis Lx. In this situation, though part of the light passes through the curved portion 42 and is radiated to outside of the light guide 4, this light is reflected on the divided reflective portion 31 of the reflector 3 provided in contact with the curved portion 42 and as a result becomes re-incident to the inside of the light guide 4 from the curved portion 42 and combined with the light internally reflected by the curved portion 42. Subsequently, light, which is internally reflected by the curved portions 42, and light, which is reflected by the divided reflective portions 31 and re-incident to the light guide 4, advance forward in the light guide 4 and are diffused (shown by nine short arrows in FIG. 2) in the right-left direction by the cylindrical steps 41 formed on the front end surface of the light guide 4 so as to pass through the front cover 2 and irradiated to the outside of the lamp. The light thus guided by the light guide 4 and irradiated is one which is on the optical axis of the LED 5; accordingly, it is high in luminous intensity.

Meanwhile, as seen from FIG. 3, light that is not incident to the light guide 4 among light radiated from the LEDs 5, namely, light directed upward or downward from the optical axis Dx of each one of the LEDs 5 passes through the light incident hole 33 and is projected on the portions of the corresponding divided reflective portion 31 of the reflector 3 that are present on the upper side and lower side of the light guide 4 and is reflected thereby. The horizontal cross section of each of the divided reflective portions 31 has a reflective surface contour that is a parabolic shape, and each LED 5 is set so as to be at substantially the focal position of the parabolic shape. Accordingly, light reflected by the top surface of the divided reflective portion 31 is, as shown in FIG. 2, directed substantially parallel to the lamp optical axis Lx direction in the horizontal direction. On the other hand, in the vertical direction, the vertical cross section of each of the divided reflective portions 31 has a reflective surface contour that is formed by a parabolic surface with respective two-stepped top and bottom portions. Accordingly, as seen from FIG. 3, light reflected by such divided reflective portion 31 is directed somewhat biased or diffused in the up-down direction and passes through the front cover 2 so as to be irradiated to the outside of the lamp. Light reflected by the divided reflective portions 31 is not aligned with the optical axis Dx of the LED 5 and is therefore radiated as light at a lower luminous intensity than the light near the optical axis Dx of the LED 5.

In view of the above, when the tail lamp described above is lit, as shown in FIG. 5A in a schematic manner, substantially the entire front surface of the lamp, i.e., the front cover 2, is uniformly illuminated by the reflected light from the reflector 3. At the same time, the front end surface of the light guide 4, i.e., an area with a striped configuration (see FIG. 2) that extends in the right-left direction from the vertically center position of the front surface of the lamp, is illuminated with a brightness higher than the reflected light from the reflector 3. Accordingly, substantially the entire surface of the lamp is uniformly illuminated at a predetermined brightness, and at the same time, a part of the lamp (the vertically central area) is illuminated in a striped configuration that is bright in the lateral direction. As a consequence, the lamp functions as a tail lamp that has a novel design.

Furthermore, in this situation, illumination of the entire lamp surface and illumination of the striped portion are both accomplished by the light radiated from the same LED 5. Accordingly, there is no particular need to provide an independent LED for the purpose of illuminating the striped portion, and consequently the quantity of LEDs used can be suppressed to a small number. It is thus possible to prevent the lamp structure from becoming complex, and it is also possible to achieve a size reduction and a cost reduction. In addition, less power consumption can be realized due to more efficient use of light radiated from LEDs.

Moreover, in the vehicular lamp described above, when the LEDs 5 are supplied with a high level of electric current in response to the operation of the brake of the automobile, the LEDs emit light of higher luminous intensity; and in this situation, light reflected by the reflector 3 and light passing through the light guide 4 respectively have a luminous intensity that is higher than when the tail lamp is lit to increase the brightness of the entire lamp surface. As a result, the lamp efficiently functions as a stop lamp. In this case as well, the respective amounts of light reflected by the reflector 3 and light passing through the light guide 4 are proportionally increased. Therefore, the appearance when the stop lamp is lit is the same as that when the tail lamp is lit, and no design novelty is lost.

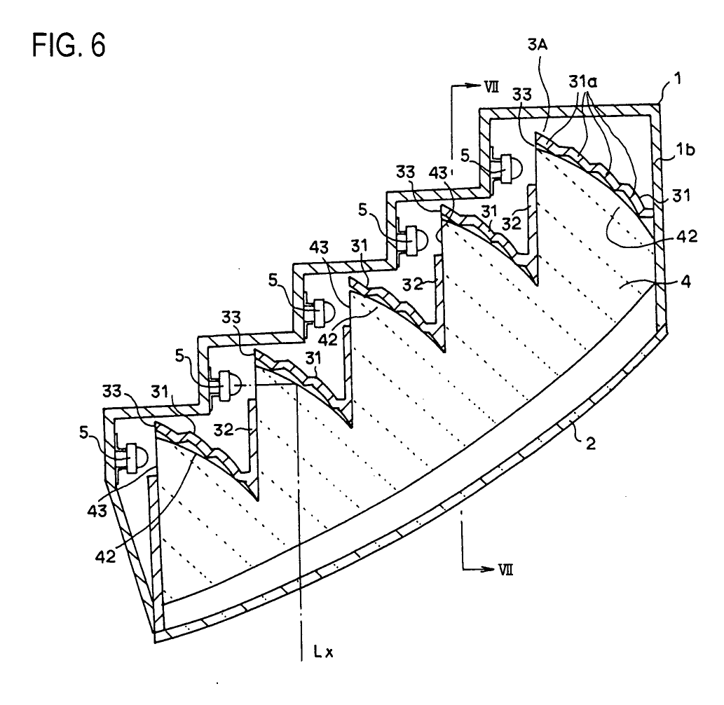

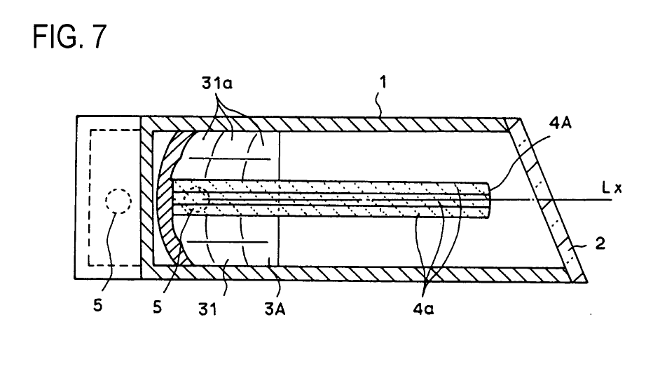

FIG. 6 shows, in horizontal cross-section, a tail lamp according to another embodiment of the present invention, and FIG. 7 shows the vertical cross-section of the same taken along the line VII-VII in FIG. 6. Component parts equivalent to those in the above-described embodiment are assigned with like reference numerals. In this embodiment of FIGS. 6 and 7, the length in the lamp optical axis direction (or the depth of the lamp) is smaller than the embodiment described above.

More specifically, in this embodiment, the reflector 3A has parabolic surfaces in a horizontal direction that comprise a plurality of divided reflective portions 31, and each of the divided reflective portions 31 is formed with a plurality of split reflective surfaces 31a in the lamp right-left direction as seen from FIG. 6. The split reflective surfaces 31a are integrally connected each other and disposed by being shifted by a small dimension in the lamp optical axis Lx direction. As a result, each of the divided reflective portions 31 of the reflector 3A provides a multi-stepped reflective surface structure whose parabolic surface contour takes an envelope curve.

In the structure of FIGS. 6 and 7, the light guide 4A has a large thickness (or lager thickness than that in the previous embodiment) in order to increase the dimension in the up-down direction of the illumination area with a striped configuration, which extends in the horizontal direction when the lamp of the present embodiment is viewed from the front. In order to obtain the thicker light guide 4A, a plurality (three in the shown embodiment as seen from FIG. 7) of light guides 4a similar to that of the previous embodiment are overlapped in the thickness direction and adhered to be integrated, thus providing a structure that functions as a single laminated light guide.

The contour or shape of the laminated light guide 4A when viewed from above is similar to that in the previous embodiment, and the curved portions 42 of the rear end surface of the laminated light guide 4A are opposedly disposed so as to contact a part of the split reflective surfaces 31a of the divided reflective portions 31. Also, the front end surface of the laminated light guide 4A is, as seen from FIG. 6, provided with no cylindrical steps 41 formed in the light guide 4 of the previous embodiment. Needless to say, each of the incident surfaces 43 on a part of the rear end surface of the laminated light guide 4A faces each of the light incident holes 33 provided on the barriers 32 of the reflector 3A.

In the lamp shown in FIGS. 6 and 7, the LEDs 5 emit light, and such light radiated from the LEDs 5 is incident to the inner surface side of the reflector 3A through the light incident holes 33 as in the previously described lamp. The majority of the light radiated toward the outer side of the vicinity of the optical axes Dx of the LEDs 5 is projected onto the divided reflective portions 31 of the reflector 3A and reflected in the forward direction of the lamp. When the light thus travels, since the divided reflective portions 31 have a multi-stepped reflective surface structure formed by the split reflective surfaces 31a aligned in the horizontal direction, light reflected by the split reflective surfaces 31a form respective light fluxes substantially parallel to the lamp optical axis. However, some light is condensed and diffused between adjacent split reflective surfaces 31a. As a result, the lamp as a whole provides such a light distribution that light is emitted in vertical stripes that are lined up horizontally. Furthermore, light in the vicinity of the optical axis Dx of each LED 5 is incident to the light guide 4A and advances in the light guide 4A to reach the front end surface thereof and subsequently irradiates from its front end surface.

In the shown embodiment, the light guide 4A is formed by laminating three layers of light guides so as to be thick; accordingly, the amount of light incident to the light guide 4A from the LEDs 5 is greater than that in the previous embodiment. Light incident to the light guide 4A advances directly along the optical axis Dx of each one of the LEDs 5, which is directed substantially perpendicular to the lamp optical axis Lx. Such light is internally reflected on the curved portion 42, i.e., the parabolic surface, of the rear end surface of the light guide 4A and reflected toward a direction along the lamp optical axis Lx. However, a part of the light passes through the curved portion 42 and is radiated from the light guide 4A, after which the light is reflected on the divided reflective portion 31 of the reflector 3A, which faces the curved portion 42, and once again incident to the internal portion of the light guide 4A from the curved portion 42. As described above, such light is combined with light internally reflected by the curved portion 42. In this situation, since the divided reflective portions 31 have a multi-stepped reflective surface structure, a light distribution with a vertically striped configuration is provided by the reflection of the plurality of split reflective surfaces 31a, and such light with a vertically striped configuration is combined with light internally reflected by the curved portion 42. As result, light radiated from the front surface of the lamp takes a vertically striped configuration despite the absence of the cylindrical steps on the front end surface of the light guide 4A.

As seen from the above, in the embodiment of FIGS. 6 and 7, as schematically shown in FIG. 5B, such a design of illumination that the up-down direction width of the illumination area having a striped configuration on the front surface of the lamp is enlarged by the light guide 4A is accomplished. Furthermore, light radiated from the light guide 4A by the split reflective surfaces 31a and light reflected by the reflector 3A have vertically striped configurations, respectively, and moreover, the vertically striped patterns of both lights coincide with each other substantially. Accordingly, the lamp provides superior design novelty when it is lit. Though the light guide 4A is large in thickness, light radiated from the LEDs 5 and incident to this thick light guide 4A is great in amount in the structure of the shown embodiment, the brightness of illumination at the front end surface of the light guide 4A is equal to or greater than that in the previous embodiment.

In addition, since the light guide 4A is formed by overlapping and integrating a plurality of light guides in the thickness direction, it can be formed in a shorter molding time as compared to forming one thick light guide, particularly in terms of the cooling-off time after molding. The occurrence of shrinking and warping can also be prevented when obtaining a light guide that has high dimensional precision.

When overlapping and integrating a plurality of light guides, thin two-sided tapes can be used to attach thin light guides together, and it is also possible to weld thin light guides together in a state of close contact with each other.

Although not shown, in the structure of FIGS. 6 and 7, a spherical type fish-eye step can be formed on the front end surface of the light guide 4A by increasing the thickness of the light guide 4A and thus increasing the height dimension of the front end surface thereof. In this structure, light radiated from the light guide 4A can be widely diffused in the up-down direction and the right-left direction, which is advantageous for increasing the visibility of the lamp. According to the present invention, the visibility can be secured over a wide range of 45° on the vehicle inner side and 80° on the vehicle outer side with respect to the lamp optical axis Lx in the right-left direction.

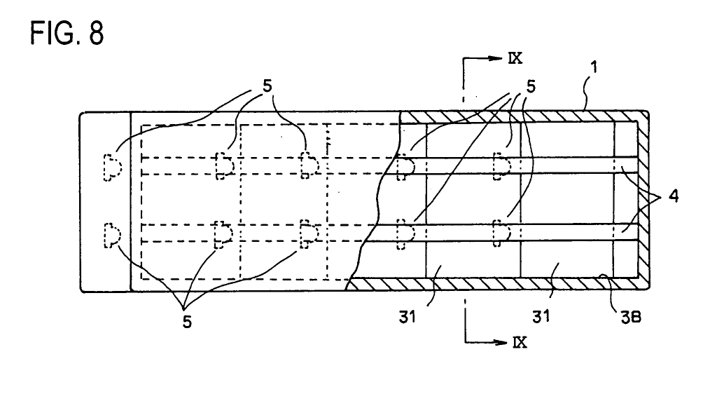

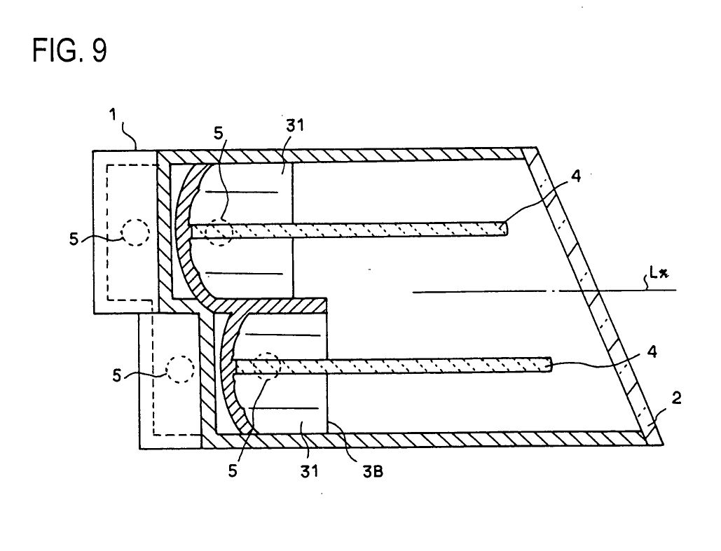

FIG. 8 is a front view of a part of a tail lamp according to still another embodiment of the present invention. FIG. 9 is a vertical cross-section taken along the line 9-9 in FIG. 8. Component parts equivalent to those in the embodiments described above are assigned with like reference numerals.

The embodiment of FIGS. 8 and 9 is to provide a lamp that emits light in which the illumination area having a striped configuration is disposed on two tiers with a predetermined space in between or in the up-down direction on the front surface of the lamp. Accordingly, the lamp is provided with two light guides 4 one over the other within the LED base 1 as seen in FIG. 9.

More specifically, each one of the light guides 4 is substantially similar to the light guide employed in the embodiment of FIGS. 1 through 4 and is fixed in the LED base 1 one over the other at a predetermined vertical interval or with a predetermined distance in between. As seen from FIG. 8, a total of ten LEDs are provided for the two, upper and lower, tiers of the light guides 4.

The reflector 3B has a horizontal cross-sectional shape similar to the reflector 3 of the embodiment of FIGS. 1 through 4; however, the cross-sectional shape in the vertical direction of each one of the divided reflective portions 31 is structured such that the parabolic surfaces similar to that in the embodiment of FIGS. 1 through 4 are respectively provided in two tiers one over the other as seen from FIG. 9. In this structure, the upper and lower divided reflective portions 31 are disposed staggered in the longitudinal direction, i.e., in the lamp optical axis Lx direction, with respect to the inclination in the up-down direction of the front cover 2.

Though not shown, respective light incident holes 33 are, similar to the structure of FIG. 2, opened in the barriers 32 of the reflector at positions corresponding to the focal points of the parabolic surfaces of the two, upper and lower, divided reflective portions 31.

LEDs 5 are disposed at positions on the LED base 1 that face the light incident holes 33. In other words, the horizontal arrangement of the LEDs 5 is similar to that in the structure of FIGS. 1 through 4 and arranged in two, upper and lower, tiers.

In the embodiment of FIGS. 8 and 9, similar to the embodiments described above, light radiated from the LEDs 5 is reflected toward the front surface of the lamp by the divided reflective portions 31 of the reflector 3B. However, in the embodiment of FIGS. 8 and 9, the reflector 3B has divided reflective portions 31 and the parabolic surface shape of each one of them has an upper tier and a lower tier, and the LEDs 5 are provided on the two, upper and lower, tiers so as to correspond thereto. Accordingly, light is reflected by the respective divided reflective portions 31 on the two, upper and lower, tiers, and thus it is possible to achieve a forward illumination that is uniform in the up-down (vertical) direction and the right-left (horizontal) direction of the front surface of the lamp.

In addition, as seen from FIG. 5C, similar to the embodiment of FIGS. 1 through 4, light of the LEDs 5 on the respective light guides 4 provided on two, upper and lower, tiers is guided toward the front surface of the lamp, and light-emitting areas with a striped configuration are formed on two, upper and lower, tiers on the front surface of the lamp by the light radiated from the front end surfaces of the light guides 4. A lamp with a novel design of light illumination is thus provided.

In the structure of FIGS. 8 and 9, more LEDs 5 are used than in the structures of the previous embodiments. Accordingly, a brightness (luminous intensity) equivalent to that for a tail lamp can be obtained, even if less electricity is supplied to the LEDs 5 than in the case of the previous two embodiments when the tail lamp is lit. On the other hand, when the stop lamp is lit, it lights up brighter than in the previous embodiments, thus assuring the safety of the automobile.

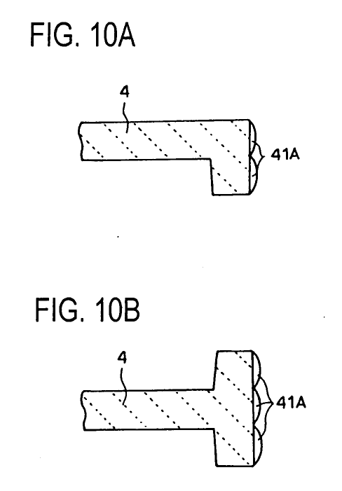

The light guides 4 in the embodiments of FIGS. 1 through 4 and FIGS. 8 and 9 can be formed so that the (vertical cross-sectional shape of the) front edge portion thereof (or the front end surface) is formed in an L-shape as shown FIG. 10A or in a T-shape as shown in FIG. 10B, so that the light guides 4 have an increased up-down dimension for the front end surfaces. With this structure, it is possible to form such steps as fish-eye steps 41A formed on the front end surface of the light guide 4 and having a high light diffusive characteristic in the up-down direction and in the right-left direction, as in the embodiment of FIGS. 6 and 7. This is advantageous for increasing the visibility of the lamp in its up-down direction and in the right-left direction. In addition, with the expanded front edge portion of the light guide 4 in an L-shape or T-shape in the vertical direction, there is no need for laminating a plurality of light guides, as in the laminated light guide 4A of the embodiment of FIGS. 6 and 7. Thus, the light guide can be formed by resin molding only, facilitating the manufacturing of the lamp.

In the lamp of the present invention, the light guide can be formed using resins that are translucent to light and colored to have the same color type as the color of light emitted by the LEDs. In this structure, since the color of the light guide can be seen from outside through the front cover, the stripes of the light guide are also visible when the lamp is not lit, and the color of the light guide reflected by the reflector can also be seen through the front cover. Thus, it is possible to provide a further improved novelty to the design of the lamp.

Moreover, the front end surface of the light guide can be embossed or the like, and it can be roughened so as to increase the light diffusive characteristic.

The light-emitting element used in the present invention is not particularly limited to LEDs described in the embodiments, and it can be other types of light-emitting elements such as electroluminescence (EL) and laser diode (LD). Also, the present invention is not particularly limited to a tail lamp and is applicable to a marker lamp or auxiliary lamp that uses light-emitting elements as the light source.

1. A vehicular lamp comprising:
a light-emitting element;
a reflector having a reflective surface for reflecting light radiated from the light-emitting element in a forward direction of the lamp; and
a flat plate-shaped light guide provided on a front side of the reflector, light radiated from the light-emitting element being incident from one side surface of the light guide and radiated in a forward direction from another side surface of the light guide, wherein
among light radiated from the light-emitting element, light in the vicinity of an optical axis of the light-emitting element is incident to the light guide, and light other than that in the vicinity of the optical axis of the light-emitting element is projected onto the reflective surface of the reflector.

2. The vehicular lamp according to claim 1, wherein a side surface of at least a part of the light guide is provided to face the reflective surface of the reflector, thus allowing light, which is incident to the light guide and radiated from the side surface of the light guide, to be re-incident to the light guide.

3. The vehicular lamp according to claim 2, wherein
a plurality of the light-emitting elements are provided at a predetermined interval in a direction along a flat surface of the light guide,
light from the respective light-emitting elements is incident to the light guide at a plurality of locations of the flat surface of the light guide, and
the reflector is provided with a plurality of reflective portions that reflect light, which is radiated from the light guide at a plurality of locations on the flat surface of the light guide, to be re-incident to the light guide.

4. The vehicular lamp according to claims 1, wherein a plurality of the flat plate-shaped light guides are laminated in a thickness direction of the light guide.

5. The vehicular lamp according to claims 1, wherein the light guide is colored so as to have a color similar to a color of light emitted from the light-emitting element.

6. The vehicular lamp according to claim 4, wherein the light guide is colored so as to have a color similar to a color of light emitted from the light-emitting element.
